(19) United States
(12) Patent Application Publication
(10) Pub. No.: US 2009/0319623 A1
(43) Pub. Date: Dec. 24, 2009

(54) RECIPIENT-DEPENDENT PRESENTATION OF ELECTRONIC MESSAGES

(75) Inventors: Suresh Srinivasan, Bangalore (IN); Rakesh Komuravelli, Hyderabad (IN); Rohit Koul, Bangalore (IN); Varun Khurana, Bangalore (IN)

Correspondence Address: Trellis Intellectual Property Law Group, PC, 1900 EMBARCADERO ROAD, SUITE 109, PALO ALTO, CA, 94303, US

(73) Assignee: Oracle International Corporation, Redwood Shores, CA (US)

(21) Appl. No.: 12/145,285

(22) Filed: Jun. 24, 2008

(51) Int. Cl. G06F 15/16

(52) U.S. Cl. 709/206

(57) ABSTRACT

A message originator, such as an author of an email, can designate “section access settings” which can selectively permit or deny access of portions of the email's content. Recipients who are not authorized may not exercise the access right upon the designated portion of content. For example, an access right may allow displaying a section of text in an email message only for specified recipients and not to other recipients. In a preferred embodiment, the entire email content, including restricted portions, is provided to all recipients, including unauthorized recipients. Unauthorized recipients are prevented from exercising the access right even though the restricted portion has been received.

### BACKGROUND

This invention is related in general to presentation of electronic information and more specifically to selective presentation of portions of electronic messages to different recipients.

Various forms of electronic messaging are in widespread use. Electronic mail (“email”), real-time chat, message boards or postings, web logs (“blogs”), web pages, etc., are each forms of electronic messaging. Some of these forms of electronic messaging play valuable roles in sensitive communications such as in business, government, or other applications where an electronic message is designed for a limited number or type of recipient.

For example, email systems provide many tools for users to maintain address books or contact lists, predefine group or distribution lists, set priorities, set delivery options, etc. However, such tools typically operate at a per-message level so that, for example, it is difficult or inefficient (and sometimes not possible) for a sender to provide an email message to multiple recipients where different recipients are only permitted to view selected portions of the email content.

### SUMMARY

A message originator, such as an author of an email, can designate “section access settings” which can selectively permit or deny access of portions of the email's content. Recipients who are not authorized may not exercise the access right upon the designated portion of content. In a preferred embodiment, the entire email content, including restricted portions, is provided to all recipients, including unauthorized recipients. Unauthorized recipients are prevented from exercising the access right even though the restricted portion has been received.

An email originator is provided with various controls and options to designate and control how different portions of an email's content are viewed. In a preferred embodiment the section access system is integrated into existing office tools or applications such as an email or other messaging program, directory services program, file maintenance system, etc. The section access system can use any suitable protocol such as Lightweight Directory Access Protocol (LDAP) to integrate with any Directory Server or a Repository such as Oracle Virtual Directory (OVD), etc. Other applications or functionality can be provided for use with embodiments of the invention such as by using an Application Program Interface (API), or other standard protocol or standalone or integrated application, as desired.

Each defined portion or section within an email message may have different section access settings. So, for example, a name of a recipient can be used to grant or deny access to a portion. A role such as “manager,” “vice president,” “group A,” or other person's name, title, management position, departmental organization, or designation can be used to set access rights. Types of access rights can include viewing, editing, forwarding, copying, etc. A particular embodiment uses tags in the email content, itself, to demarcate portions. Different approaches to controlling the access rights are possible. For example, public/private key pair encryption systems can be used. Other rights management or authentication approaches can also be used, as described below.

An originator or other sender of a message can invoke section access settings by using a menu or other control system. Default settings can be used so that a sender does not necessarily need to specify settings all the time. For example, sections or types of text that have had restricted access settings before can be automatically identified and the prior (or default) settings can be used again without the need for a sender to specify the settings.

Presentation of an email with section access settings can be configured in different ways. For example, recipients can be shown that portions of the email content have been removed from access. A line of text or a symbol can indicate that text has been omitted. Recipients who are able to view portions of content that are blocked from one or more other recipients may see the restricted portions indicated as, for example, by highlighting the text, indenting text, using a different font, rendering, animation or other presentation effect. Names or groups of restricted or permitted recipients may be shown to one or more of the recipients.

In a particular embodiment, a sender of the email message can set a forwarding permission on a per recipient level. If recipient A, who does not have the forward right, forwards the mail, the mail is received as a blank mail. The content is present, but is not visible to any of the recipients forwarded subsequently. A recipient who has the forward right is allowed to forward the mail and the section access settings, including view permissions, if any, are applied on the recipient end. A particular embodiment of the above can be implemented by a setting that denies any or all of the recipients from further forwarding the mail. In this case even if an attempt is made to forward the mail, the recipient will see only a blank mail. Even though different views are provided to different recipients, the same message version (e.g., the entire email content) can be provided to each recipient so that a recipient may be able to view portions that a sender (other than the originator) could not view.

### BRIEF DESCRIPTION OF THE DRAWINGS

FIG. 1 is a first display of an email composition interface;

FIG. 2 is a second display of an email composition interface;

FIG. 3 is a third display of an email composition interface;

FIG. 4 is a fourth display of an email composition interface;

FIG. 5 illustrates session access rights tags inserted into email content;

FIG. 6 illustrates different views of a document according to a recipient category data type matching with section access settings;

FIG. 7 is a first rendering of a view of message content;

FIG. 8 is a second rendering of a view of message content;

FIG. 9 is a third rendering of a view of message content;

FIG. 10 is a fourth rendering of a view of message content;

FIG. 11 illustrates recipients having different views of a same message content; and

FIG. 12 illustrates basic components in a communication network suitable for use with embodiments of the invention.

### DETAILED DESCRIPTION OF EMBODIMENTS

A particular embodiment of the invention allows an email originator to define “section access settings” for different parts of an email message. Each section or portion can have one or more rights associated with it such as to allow a specific one or more recipients to view, edit, copy or perform some other action with or on the corresponding section. In a particular embodiment, forward permissions apply at a per mail or per recipient level, and NOT at a sectional level.

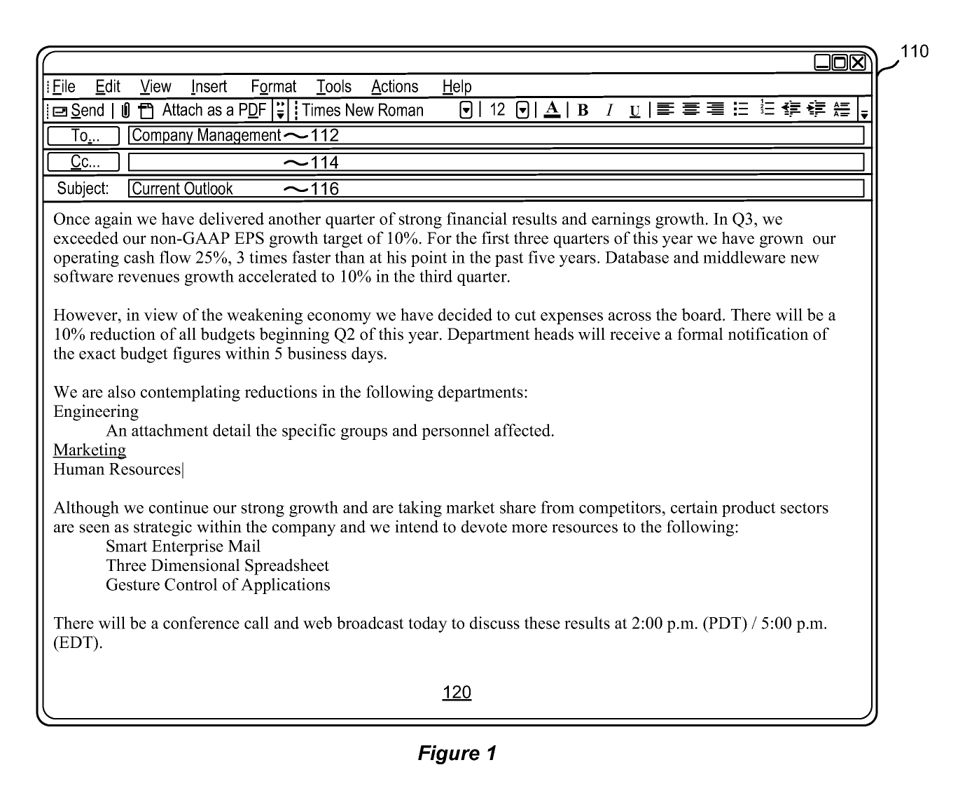

FIG. 1 illustrates an email composition interface as it could appear on a display screen of a computing device. In FIG. 1, window 110 includes traditional email controls and input areas. The “To” input area 112 lists an email group called “Company Management” as the recipient. As is known in the art, a group such as “Company Management” could have many specific people named as recipients. For example, such a group could include mid-level managers such as group leaders on up. In general, any method of declaring recipients is suitable for use with embodiments of the invention. Individual names or additional groups can be entered by typing the names, by selecting from an address book, contact list, most recently used list, etc. Recipients can be included in the “CC” area 114 or in other areas (e.g., “BCC”—not shown). For purposes of illustration, only a few email features are described. It should be apparent that many other useful email or electronic messaging features in use today (or future-developed) may be adapted for use with features of embodiments of the invention. Also, although the invention is described herein primarily with respect to an email system, different embodiments may incorporate one or more of the described features to other electronic messaging systems such as chat, blogs, web postings, electronic documents, etc.

Subject line 116 includes a subject description or title. Although section access settings are described below primarily with respect to the message body, other embodiments may use such section access setting in any other input area of an email message that could be displayed or used by a recipient. For example, a message originator may wish to prevent some recipients from seeing part of a subject line, attachments, security settings, other recipients, etc.

Message body 120 includes text entered by the message originator to arrive at the display shown in FIG. 1. After entering text the originator may apply section access settings. Note that section access settings can be applied to any text or even blank area before the message is completed. Even after defining section access settings the text to which the settings apply can be deleted or moved and the section access settings can be deleted or moved along with the associated text. A particular embodiment of the invention uses tags embedded with the text to define the section access settings. The tags are described in more detail below. This allows the tags to be treated as markers or indicators much like formatting markers (e.g., font size, font type, underlining, etc.). The tags need not be visible while editing the text or setting access settings. In the present example, the tag display is suppressed or not visible.

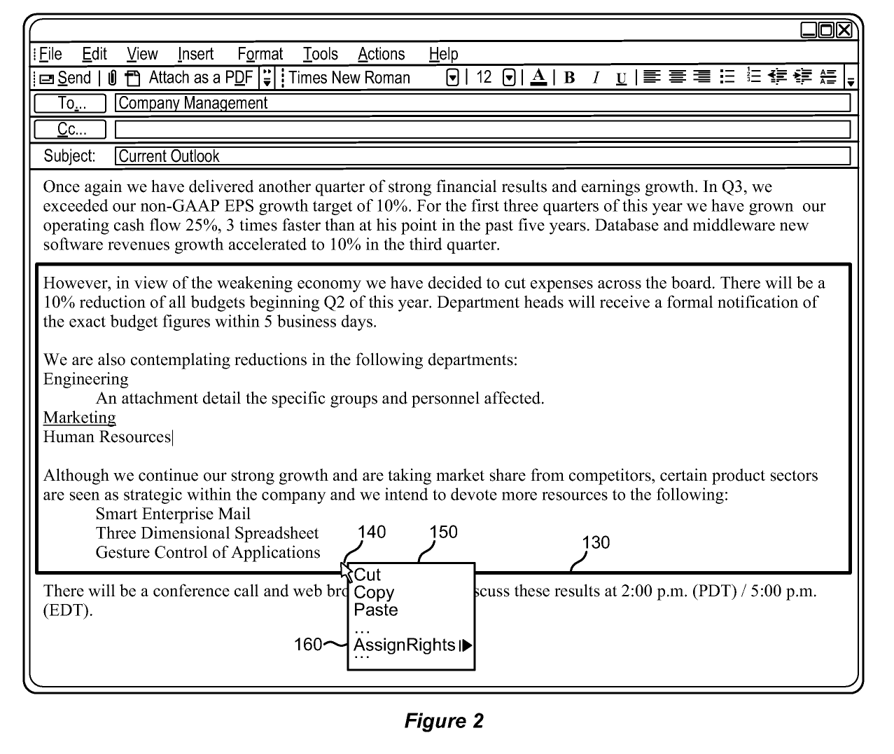

FIG. 2 shows box 130 around text selected by the message originator. The selection of text can be in a manner known in the art. For example, a user can use a mouse or other pointing device to move a pointer such as pointer 140 to select and drag across the text. This typically results in a highlighting effect of the selected text in box 130. Any other way of selecting text can be adapted for use with embodiments of the invention. In general, variations on specific user interface actions and displays are possible and are within the scope of the invention.

Pointer 140 is placed within box 130 and a mouse input device is right-clicked to bring up menu 150. Menu 150 can include standard word-processing options such as “Cut,” “Copy,” “Paste,” etc. Also included within menu 150 is an “AssignRights” option 160.

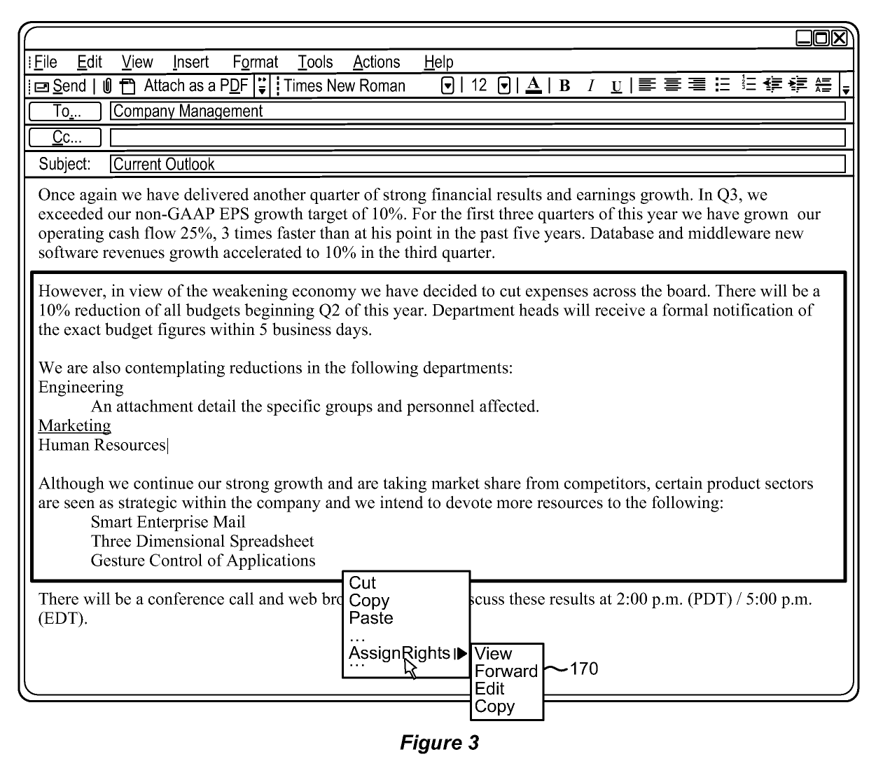

FIG. 3 shows the display after the user has selected “AssignRights” option 160 in FIG. 2. Specific rights that can be assigned are listed in sub menu 170. These specific rights can include “View,” “Edit,” and “Copy.” The number of times a right can be exercised on the text portion can be set (e.g., allowing a section to be viewed only once).

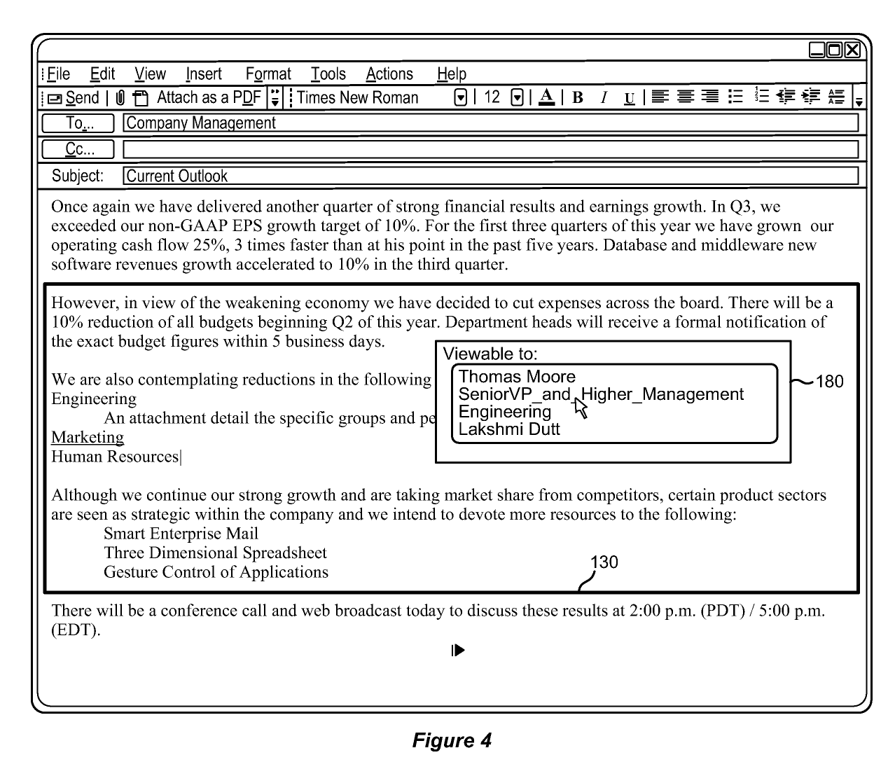

FIG. 4 shows the display after the user has selected “View” from sub menu 170 in FIG. 3. In FIG. 4, dialog box 180 appears to assign viewing rights. In this example, a list of contacts defined in the originator's email program is shown. The entries in the list can include names of single persons (e.g., Thomas Moore) or predefined groups such as “SeniorVP_and_Higher_Management” or “Engineering.” The manner of displaying and selection of recipients for assignment of rights can vary. In FIG. 4, the originator/user is setting the “View” right of the text section in box 130 to the group of recipients defined in “SeniorVP_and_Higher_Management.” After the user clicks on this sub menu entry dialog box 180 disappears. As mentioned above, the tags are not shown in this embodiment but they can be shown, if desired. For example, an icon or menu option on a toolbar in the email program can allow a user to turn the tags on or off. Typically, a start tag will be inserted at the top of the text in box 130 and an end tag will be inserted at the bottom of the text in box 130. Other embodiments can use color highlighting to indicate rights that are set for specific sections. Or the names of recipients or groups of recipients who are given rights to a specific section can be shown adjacent to that specific section. Other approaches are possible. The process of selecting text and defining settings continues until the originator has set all desired rights. Multiple rights can be combined using Logical Operators. Eg: The view right is: Director AND VP AND (NOT Lakshmi Dutt).

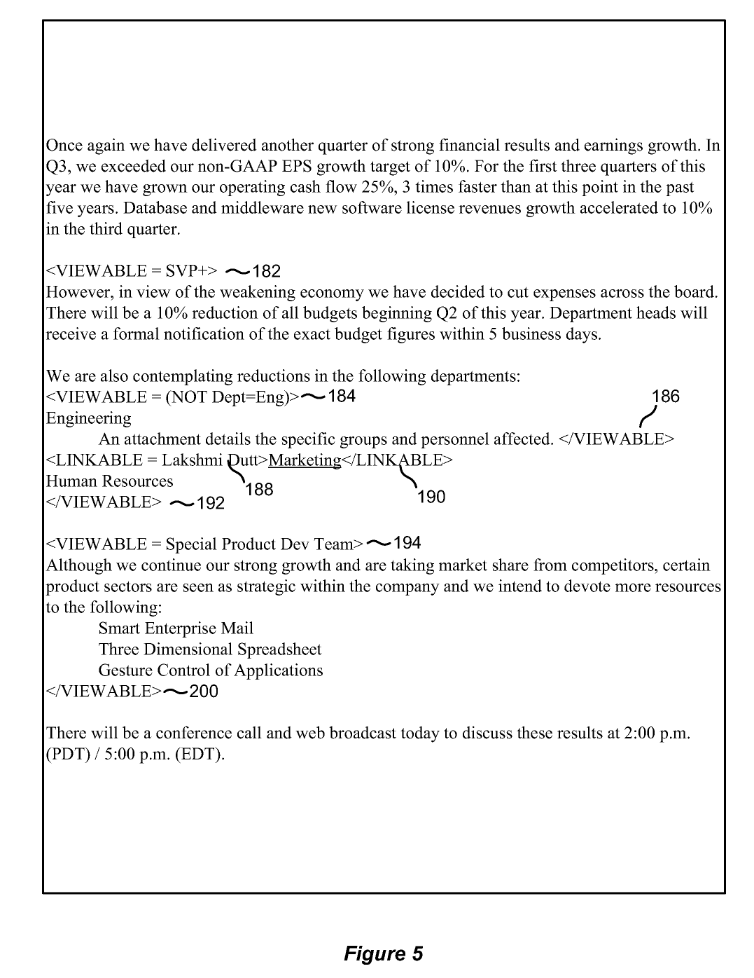

FIG. 5 shows the text with several tags. This view may be show, for example, if an option to “show tags” is selected. FIG. 5 illustrates the “source” of the email content which would not normally be shown during editing or to recipients who did not have a right set to see the source content. The tags show all section access settings set by the originator in the present example. Tag 182 is the result of the selection of the text in box 130 and the “View” right assigned to that text for “SeniorVP_and_Higher_Management”. Thus, tag 182 is a start tag and it corresponds (i.e., is nested with) tag 200 which is an end tag corresponding to tag 182. The format and operation of such tags are known in the art and are used, for example, in languages such as Hyper-Text Markup Language (HTML), Extensible Markup Language (XML), etc. Various features of known tag structure and syntax can be applied to the tag syntax described herein, unless otherwise noted.

Tag 182 shows that the right “VIEWABLE” is set to allow the predefined group “SVP+” to have viewing access. “SVP+” can correspond with, or be mapped to, a group that is defined by the originator locally or by an administrator or other person who has made the group definition available globally to other users of the email system. Tag 200 terminates the demarcated text to which tag 182 applies.

Tag 184 shows that the originator has selected the text between tag 184 and tag 186 to not be viewable by the engineering departments. The attribute names and values such as “Dept” (an attribute) and “Eng” (a variable) can be defined when the features are implemented in an email system or other application. In such a case they would be defined by a software manufacturer. Alternatively, a system administrator can define the variables at a time of setting up or configuring an email system with section access setting ability. Another possibility is to allow users of the system to define attribute/values and other parameters of the system.

The text between tags 188 and 190 includes a hyperlink that has an indicator which is only viewable and operable by a recipient named “Lakshmi Dutt,” as defined by the “LINKABLE” tag. The hyperlink is to an external document, such as a document on the company network or the Internet, so that recipients other than Lakshmi Dutt will not be able to access the hyperlink or external document, or even to know that the word “Marketing” is associated with a hyperlink.

Text between tags 194 and 200 is only viewable by a group of recipients identified as belonging to a “Special Product Dev Team”. In the present example, it is assumed that the originator has set a “no forwarding” option for the email message. This prevents any recipient from forwarding viewable content to other recipients. As described, below, if a message with forward-prevented content is forwarded, the recipient of the forwarded message is not able to view the message content but may still see the sender's name. In this case, as in the other transfer cases discussed, herein, the entire content of the message can still be transferred to the recipients upon forwarding, but the ability to present, or view, the content is prevented at the recipients' client processes.

FIG. 6 illustrates different views of the document according to the recipient and to the section access settings in the example of FIG. 5. In FIG. 6, the different renderings, or views, of the content are shown symbolically using the tag reference numbers of FIG. 5 as delimiters.

For example, view 302 represents the complete content as displayed to the originator of the message, as shown in FIG. 1. Text at 304 and 310 corresponds with untagged text 181 and 199, respectively, in FIG. 5, which renders to the text 117 and 119, respectively, in the view shown in FIG. 1. Symbolic text shown at 306 in FIG. 6 is delimited by the tag reference numbers 182 and 192. This symbolic text in FIG. 6 corresponds with text 183 that is within tags 182 and 192 of FIG. 5 and is rendered as text 120 in FIG. 1. In general, the tag delimiters of FIG. 6 correspond with the tags using the same reference numbers in FIG. 5. It should be apparent that FIG. 6 is only for illustration purposes to discuss exemplary section access settings on different views in different content distributions to various recipients.

View 320 shows a rendering of the content to a recipient who is a Senior VP or above, who is not on a Special Products Development Team, who is not in Engineering and who is not Lakshmi Dutt. In view 320, the untagged text is shown at 322 and 326 in the same manner it is displayed for view 302 (and all other renderings of the message). In a particular embodiment, the entire content and tags of FIG. 5 are transferred to each recipient. Each recipient is associated with type data that identifies the recipient to the system. The type data is compared to the section access settings and if there is a match, or the condition is otherwise met, any right associated with the condition is permitted to or by the associated recipient, or to an account, device, application or other mechanism associated with the recipient.

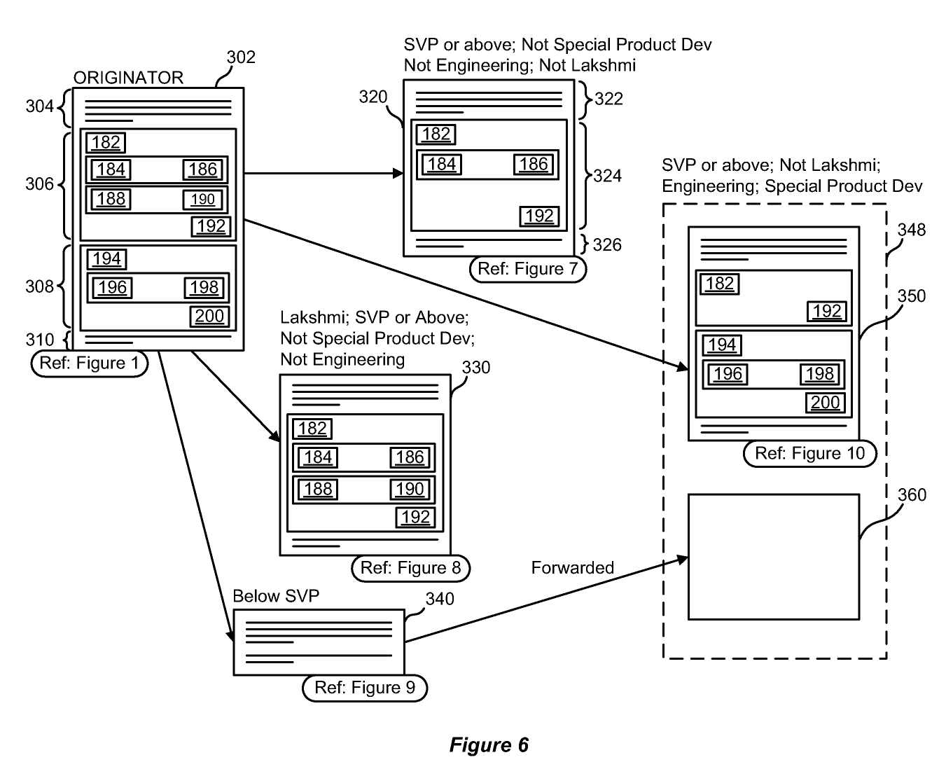

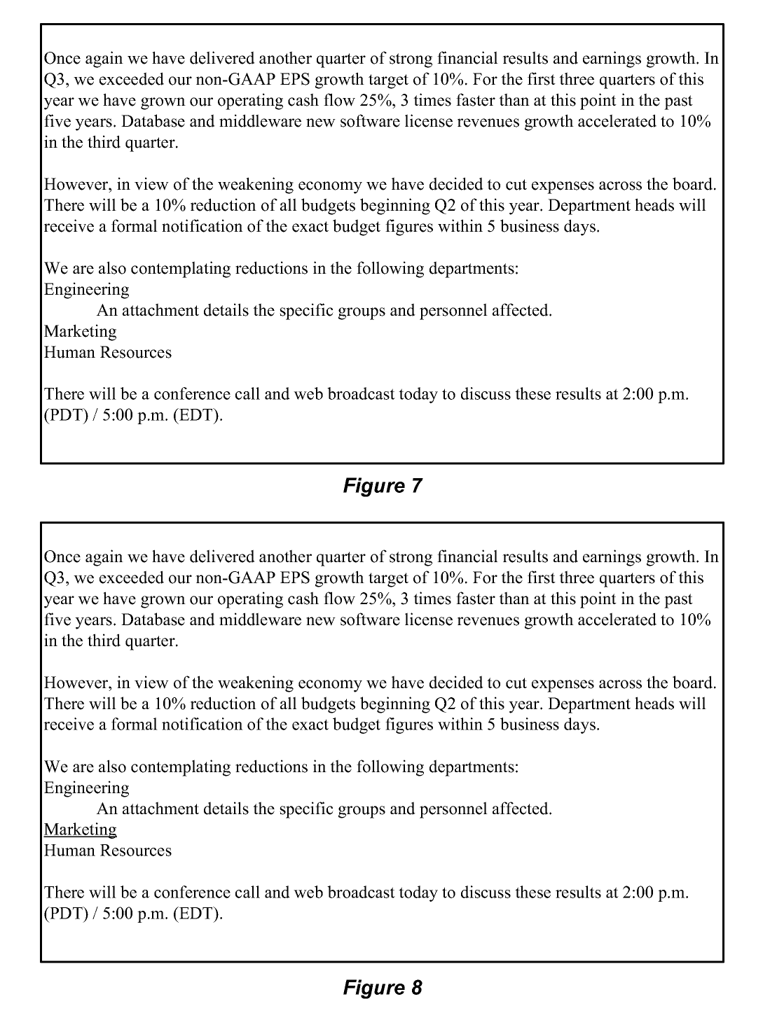

In view 320, the type data for a recipient in the category of {Senior VP or above; NOT Special Product Dev; NOT Engineering; NOT Lakshmi Dutt} permits viewing of text 324 delimited by tags 182 and 192. The text between tags 182 and 192 is controlled by the tag <VIEWABLE=SVP+> so that, since the recipients of view 320 are at Senior VP or above, the text 182/192 is viewable to the recipients in this category. Similarly, text 184/186 has the condition <VIEWABLE=(NOT Dept=Eng)> and since the recipients in this category are not in the engineering department the condition is met so text 184/186 is viewable. The rendering of 188/190 has the condition <LINKABLE=Lakshmi Dutt> which is a condition that is not met by the recipients in this category. Since the condition is not met the link for 188/190 is not shown or enabled. Typically, hyperlinks can be shown by underlining, different colored text, etc. Such an indicator would not be visible to the recipients in the category of view 320 and no ability to click the word “Marketing” to see the associated document is provided. The text 194/200 (see 308) is not rendered in view 320 since this category of recipient are not members of the Special Products Development Team. The rendering of view 320 is shown in FIG. 7.

View 330 is presented to recipients in the category of {Lakshmi; SVP or Above; NOT Special Products Dev; NOT Engineering}. In this view, text 182/192 is visible as with view 320. However, since this recipient is Lakshmi Dutt (or an account, device or process associated with or permitted to Lakshmi Dutt), the condition for 188/190 is also met so that the word “Marketing” is shown with a hyperlink indicator (i.e., underlined in this case) and the recipient, Lakshmi Dutt, can click the link to obtain the document, if desired. The text 194/200 (see 308) is not rendered in view 320 since Lakshmi Dutt is not a member of the Special Products Development Team. The rendering for view 330 is shown in FIG. 8.

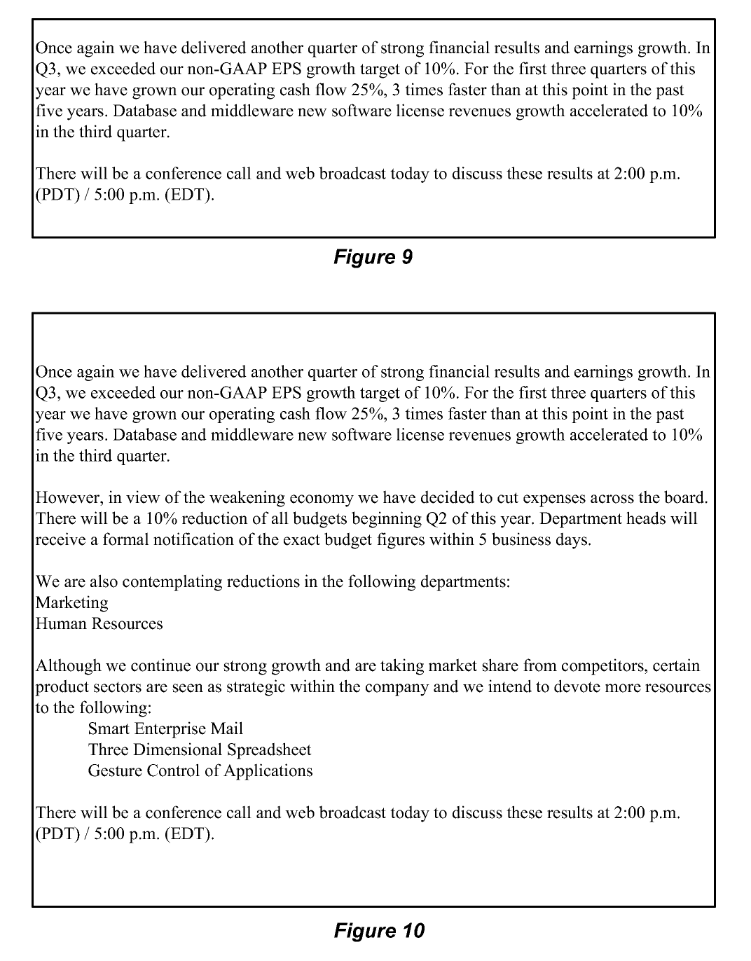

View 340 illustrates the rendering of content to users who are at Senior VP or lower but who named in the originator's group email “Company Management” to whom the original message has been sent. As shown, view 340 only presents, or renders, the untagged text since the text 182/192 and 194/200 does not meet their section access setting conditions. The rendering for view 330 is shown at FIG. 9.

View 350 shows a rendering of the content to a user who is in category 348 {SVP or Above; NOT Lakshmi Dutt; is Engineering; is Special Products Dev}. A user in this category is presented with all of the original text except for 184/186 (since the user is Engineering, i.e., they are not “NOT Engineering”) and 188/190 (since the user is not Lakshmi). A rendering for view 350 is shown in FIG. 10.

View 360 shows the event where a recipient of view 340 has forwarded the message to a recipient in category 348. Since forwarding ability has been prevented by the originator, no recipients of a forwarded version of the email are able to see any of the content of the email. Note that any forwarding of the content, even from a user back to the same user, would prevent the presentation of the email content. In a particular embodiment, a recipient of a forwarded message where forwarding is prevented still receives a message in the recipient's in-box. The forwarding sender's name appears in the “From:” line but the subject, text body, and other fields will be blank. This allows a recipient of a forward-prevented message from detecting that the forwarding sender intended to send something that was prevented from view or other access by the recipient. Other types of “transfer” related conditions on text or other portions of a message are possible. For example, a restriction can be made to prevent the message portion from being presented to a “CC” recipient, “BCC” recipient, forwarding beyond a time interval (e.g., no transfer after 1 week), etc.

Variations are possible from the specific mechanisms discussed above. For example, various approaches can be used to maintain and check a recipient's type data against a section access setting condition. A user's category properties can be maintained by a corporate email system, virtual directory system, shared database records, attributes in a user's, device's or application's account record; etc. The type data can be set up and maintained by an administrator/manager human or process or by the users, themselves, or by a combination of such entities.

To further illustrate features, several use cases are described, as follows:

Use Case 1: An originator is organizing a birthday party for a co-worker. For a mail that has 10 recipients, 9 people can be flagged to see the entire content, whereas the birthday boy will see only a portion of the mail. The portion that is visible to others but not to the birthday boy could include information such as surprise to be shared, cost and so on.

Use Case 2: VP1 needs to send a mail to Director D1 and Manager M1. This mail has sensitive content that the VP does not intend to share with anyone other than his directors. So, the VP sends one mail with all the information. The sensitive data is “marked” with section access settings such that only Directors and above in the organization hierarchy are allowed to be privy to that information. The other section of the mail is marked such that Managers and above will be privy to it. The rest of the mail is Generic (G) and everyone is allowed to read it.

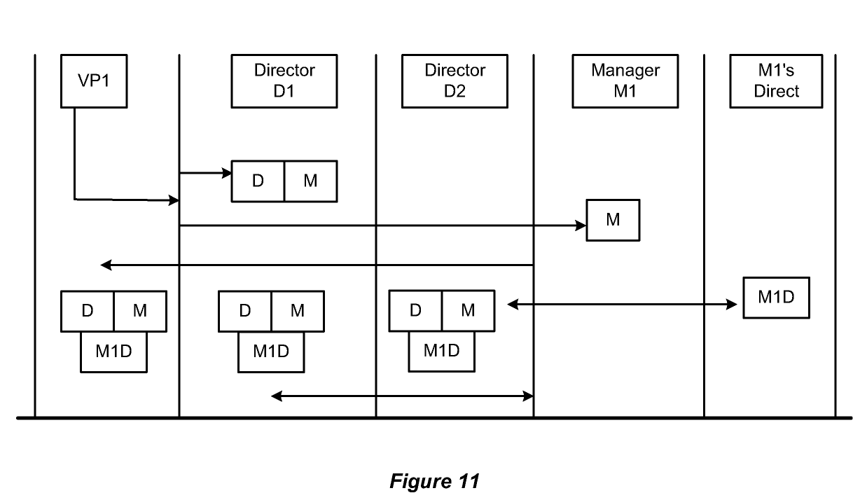

FIG. 11 illustrates this scenario in diagram form. Director D1 sees content: D+M+G while Manager M1 sees content: M+G.

Next, Manager M1 replies with text (M1D) to VP1's mail, and adds Director 2 and his own (M1) direct to the mail. Now, VP1 sees content D+M+G+M1D; Director D1 sees content D+M+G+M1D; Director D2 sees content D+M+G+M1D; and M1's Direct sees content G+M1D. In a particular embodiment the process of receiving and viewing message content is transparent (i.e., not noticeably different from receiving other email without features described herein) to the recipient. The recipient is unaware of the presence of “secure” information that he/she is not privy to.

Use Case 3: Embodiments of the invention can provide individual levels of segregation of information. For example, a VP needs to send a mail to Director (D) and Manager (M). This mail has sensitive content that the VP does not intend to share with anyone other than Director D only. The other content is visible to the manager M. Manager M replies to both the Director and the VP. A part of this mail is visible only to the director and the rest of the mail is visible to both the director and the VP. Director D sees content M+D while Manager M sees content M.

Next, Manager M replies with text (RG+RD) to the VP's mail with content that is visible only to the Director (RD) and the other part that is visible to both the Director and the VP (RG). VP sees content D+M+RG while Director D sees content D+M+RG+RD. Again, the receipt and presentation of different views of a same message content can be transparent to the recipients (and, in some cases, senders).

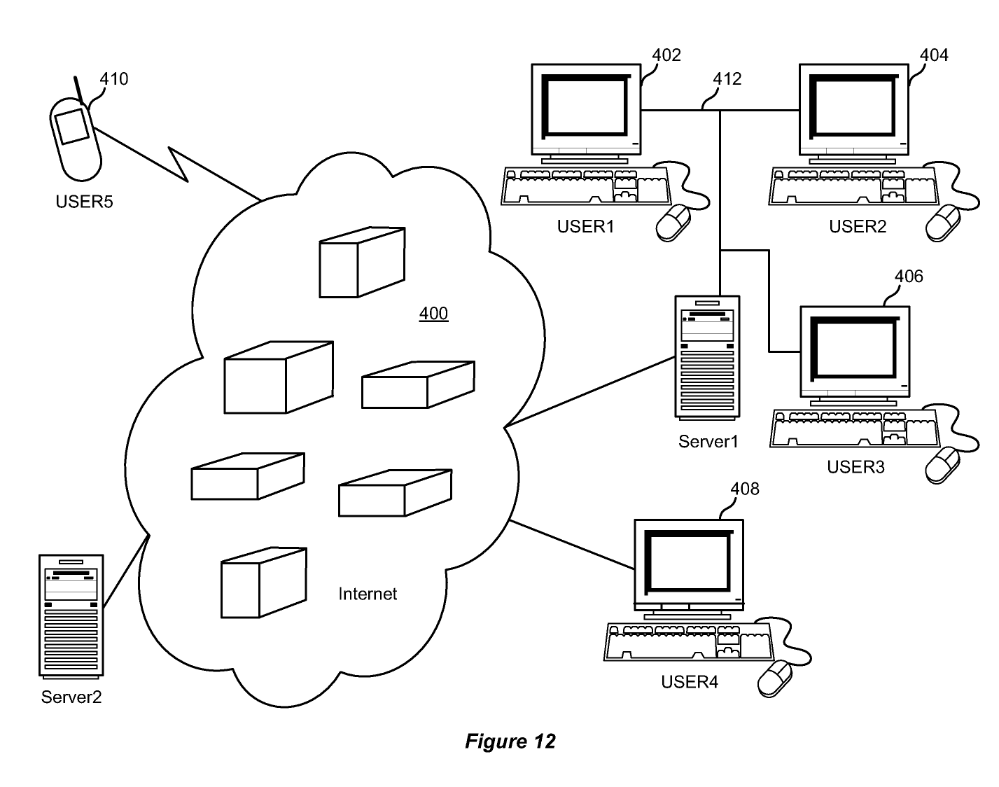

FIG. 12 provides an example of a digital network that can be used to achieve transfers of electronic messages according to embodiments of the invention. FIG. 12 is a basic illustration designed to show components and conceptual interconnections and many variations from FIG. 12 are possible. For ease of discussion only a few elements are shown where in an actual application there may be hundreds, thousands or more hardware and software components in a communication network or system.

In FIG. 12, users such as USER1-5 operate processing devices such as computer systems 402-408 or other processing devices such as cell phone 410. In general, any processing device that can be provided with suitable messaging functionality may be employed. Transfers among user devices can be by local area network (LAN) such as LAN 412, corporate or campus networks, home network, Internet 400 or other local or global networks. Link transmissions can be by wired or wireless connection. Any suitable communication protocols or modes can be used. Internet 400 includes many components such as routers, servers, network processors, storage devices, etc. These are illustrated generally by the blocks within Internet 400.

In a particular embodiment, an email server acts as a hub for email exchanges in a corporate environment. For example, Server1 and users USER1-3 can be in communication in a corporate network as, for example, via an email system. Users or servers such as USER4, USER5 and Server2 can be at geographically distant locations from the corporate environment and can also be part of the email system. An email server program may reside on Server1 and each user can operate an email client. In other applications, different parts of the email system (or other communication system) can reside in whole or in part on any of the components shown in FIG. 12.

In one embodiment, encryption is used in order to protect portions of the message content from various types of rights access according to the section access settings. For example, text between tags that is restricted from viewing can be encrypted. The tags themselves may also be encrypted so that the nature of the condition required to access protected text is not disclosed. A public key system along with a key server and optional authentication server (or other secure access control components) can be used to require a client process to be verified for access. The verification/authentication can be performed by a process at the client's side or it can be a process executing in the email server or on a dedicated server. Any suitable type of authentication/encryption can be adapted for use with embodiments of the invention to control access rights. A particular embodiment uses the access control mechanisms included within a virtual directory system such as Oracle Virtual Directory (OVD, e.g., version 10.1.4), manufactured and distributed by Oracle Corp. OVD is an identity aggregator that has around 400+adaptors that talk to the underlying Identity Stores (LDAP based, File System, Database, and so on) An application meets its requirements by querying the OVD instead of the individual underlying Identity stores to retrieve the user attributes and/or authenticate the user. In this manner, corporate email clients are able to retrieve the user details from the directory (Auto complete feature, etc.) Other suitable security systems may be employed.

Although embodiments of the invention have been described as features in other existing applications, the functionality described herein may be deployed in any suitable manner. For example, rather than integrating the features into a third-party email program, the features can be provided as a stand-alone email program, a web-based application, an applet, widget, plug-in, or in any other suitable manner. Functions can be implemented in software, hardware or a combination of both, as desired.

Although embodiments have been described primarily with the use of tags, other types of tags or way of associating a condition with a portion of a message can be used. For example, codes included with an email message can point to address locations or otherwise serve as indexes into the message content to describe the condition to be met and the start and/or end of the text to which the condition applies. The codes can be stored in a file that is separate from the message content. A plugin-based mechanism can be used. Many different message portions can be the subject of a condition or restriction. In addition to text, other message portions include attachments, audio, images, hyperlinks, etc.

Any suitable programming language can be used to implement the routines including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable storage device” can include electronic, magnetic, optical, electromagnetic, mechanical and/or electromechanical media, devices or software. In general, any suitable apparatus for providing information such as instructions or data to a processor can be used to achieve all or a portion of the functionality described herein.

A “processor” or “process” can include any hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions described herein can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while embodiments of the present invention have been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

We claim:

1. A method for transferring email content to a plurality of recipients, the method comprising:
accepting a signal from a user input device to designate first and second recipients;
accepting a signal from a user input device to indicate that the first recipient is granted an access right to a particular portion of the email content;
accepting a signal from a user input device to indicate that the second recipient is denied the access right to the particular portion of the email content; and
transferring the entire email content to both the first and second recipients.

2. The method of claim 1, wherein the access right includes viewing the particular portion.

3. The method of claim 2, wherein an indication of non-displaying of the particular portion of the email content is presented to the second recipient upon the second recipient's viewing of the transferred entire email content.

4. The method of claim 1, wherein the access right includes editing the particular portion.

5. The method of claim 1, further comprising:
accepting a signal from a user input device to indicate that the email content is not forwardable, wherein all information besides a forwarding person's name in a forwarded version of the message will not be displayed.

6. The method of claim 1, wherein the access right includes copying the particular portion.

7. The method of claim 1, further comprising:
including a start tag in the email content, wherein the tag indicates a start of the particular portion.

8. The method of claim 1, further comprising:
encrypting the particular portion;
associating a decryption key with the particular portion; and
providing access to the decryption key to the first recipient.

9. The method of claim 1, further comprising:
authenticating the first recipient to an authentication system as a precondition to displaying the particular portion to the first recipient.

10. A computer-readable storage device including instructions executable by a processor for displaying email content, the computer-readable storage device comprising one or more instructions for:
receiving the email content for an indicated recipient, wherein the email content includes a particular portion having an associated access right;
identifying an access right associated with the particular portion;
determining whether the recipient is granted the access right; and
allowing the recipient to exercise the access right only if the recipient is granted the access right.

11. The method of claim 10, wherein tags are used within the email content to define the particular portion.

12. The method of claim 10, wherein the access right includes viewing the particular portion.

13. The method of claim 12, further comprising:
determining that the recipient does not have the access right; and
optionally displaying an indicator to show that the particular portion is not being displayed.

14. The method of claim 10, further comprising:
accepting a signal from the user input device to indicate that the email content should be forwarded to a new recipient, wherein the new recipient has the access right; and
sending the email content to the new recipient for exercising of the access right.

15. The method of claim 10, further comprising:
displaying a list of at least a portion of recipients of the email message; and
indicating whether one or more of the displayed recipients is associated with an access right to the particular portion.

16. The method of claim 10, further comprising:
determining that the recipient has an access right to view the particular portion; and
displaying the particular portion with a visual effect to indicate that one or more other recipients do not have the access right to view the particular portion.

17. The method of claim 16, wherein the visual effect includes highlighting text corresponding to the particular portion.

18. The method of claim 16, wherein the visual effect includes emboldening text corresponding to the particular portion.

19. An apparatus for transferring email content to a plurality of recipients, the apparatus comprising:
a processor;
a computer-readable storage device including one or more instructions executable by the processor for:
accepting a signal from a user input device to designate first and second recipients;
accepting a signal from a user input device to indicate that the first recipient is granted an access right to a particular portion of the email content;
accepting a signal from a user input device to indicate that the second recipient is denied the access right to the particular portion of the email content; and
transferring the entire email content to both the first and second recipients.

20. A computer-readable storage device including one or more instructions executable by a processor for:
accepting a signal from a user input device to designate first and second recipients;
accepting a signal from a user input device to indicate that the first recipient is granted an access right to a particular portion of the email content;
accepting a signal from a user input device to indicate that the second recipient is denied the access right to the particular portion of the email content; and
transferring the entire email content to both the first and second recipients.

21. A method for presenting email content to a recipient, the method comprising:
receiving the email content;
receiving an indicator of an access right for a portion of the content; and
displaying the email content by omitting display of the portion of the content to which the access right applies.
